(19) United States
(12) Patent Application Publication
(10) Pub. No.: US 2018/0141153 A1
(43) Pub. Date: May 24, 2018

(54) OPTICAL SYSTEM FOR FOCUSING A HIGH ENERGY LASER

(71) Applicant: Inasco Asbestos Converting AB, Lidingö (SE)

(72) Inventors: Knyaz Rikard Emanuel Högberg, STOCKHOLM (SE); Yuri Viktorovich Stolyarov, St. Petersburg (RU)

(21) Appl. No.: 15/523,996

(22) PCT Filed: Nov. 4, 2014
(86) PCT No.: PCT/SE2014/051305

§ 371 Date: May 3, 2017

(51) Int. Cl. B23K 26/064; G02B 13/18; G02B 19/00; G02B 9/12

(52) U.S. Cl. CPC B23K 26/064; G02B 13/18; G02B 9/12; G02B 19/0047; G02B 19/0014

(57) ABSTRACT

A system for focusing of a high energy laser at an extended distance. Particularly, an optical system that includes a first lens element that has a first surface and a second surface, where the first surface is concave and the second surface is convex, a second lens element that has a first surface and a second surface, where the first surface is flat and the second surface is concave, a third lens element that has a first surface and a second surface, where the first surface is flat and the second surface is convex and where the distance between the second lens element and the third lens element is larger than the distance between the first lens element and the second lens element.

### TECHNICAL FIELD

The present specification generally relates to the field of optical systems for lasers and particularly discloses a system for focusing of a high energy laser at an extended distance.

### TECHNICAL BACKGROUND

Generally, lasers for cutting uses a focused laser beam which either melts, burns or vaporizes away material. The cutting process depends on the power of the laser and the ability to focus the laser beam where the cutting is directed. The focus distance for common industrial systems are on the scale of hundreds of a meter.

A rise in output power from laser, such as from fiber laser sources have led to a range of laser systems. In the general case for a fiber laser, the increased output power is possible due to several factors, including development of large mode diameter double clad fibers and the increase in power and brightness of diode pumps.

However, optical systems for lasers do not offer the ability to utilize a high energy laser in combination with the ability to focus at an extended distance in a mobile environment. Common methods of focusing a laser at an extended distance do not work with high energy lasers and common methods of focusing a high energy laser do not work with extended focus distances.

Further, the concept of a high power laser in a mobile environment is associated with problems related to cooling and durability of the apparatus.

Thus, the inventors of the present invention have identified a need for an improved optical system that is designed to overcome the problems stated above.

One object of the present invention is to provide an optical system which is capable of focusing a high power laser at extended distances with high demands on the robustness needed in mobile applications.

### SUMMARY OF THE INVENTION

The above-mentioned requirements are achieved by the optical system defined by the independent claim. Preferred embodiments are set forth in the dependent claims.

The present invention relates to an optical system for focusing a high energy laser at an extended distance. The optical system comprises, in order as viewed from the laser source, along an optical axis of the system:
A first lens element having a first surface and a second surface, where the first surface is concave and the second surface is convex;
A second lens element having a first surface and a second surface, where the first surface is flat and the second surface is concave;
A third lens element having a first surface and a second surface, where the first surface is flat and the second surface is convex and in the optical system the distance between the second lens element and the third lens element is larger than the distance between the first lens element and the second lens element.

The terms “first surface” and “second surface” refers to an optical elements first and second surface as viewed from a specified direction.

The term “extended distance” may for an example mean a distance longer than 5, 10, 50, 100 or 500 meters.

The invention is based on the insight that the demands on mobility and cooling in the present application can be solved with a fiber laser. The fiber laser as such is a robust construction where the multiple fiber strands it can be made of increase the surface area available for cooling, hence an effective cooling can be achieved in combination with a robust construction that is suitable for mobile usage. However, utilizing a high power fiber laser is associated with problems related to the ability to focus on extended distances.

Thus, the inventors of the present invention have identified an improved optical system defined above that is designed to focus a high power fiber laser at extended distances.

In one embodiment of the invention, the first surface of the first lens element have a radius of curvature of in the span of in the span of 162 mm to 179 mm, the second surface of the first lens element have a radius of curvature in the span of 42 mm to 47 mm, the second surface of the second lens element have a radius of curvature in the span of 28 mm to 31 mm and the second surface of the second lens element have a radius of curvature in the span of 407 mm to 450 mm. This design improves the precision of the optical system.

In one embodiment of the invention, the first surface of the first lens element have a radius of curvature of in the span of in the span of 169 mm to 172 mm, the second surface of the first lens element have a radius of curvature in the span of 44 mm to 4 5mm, the second surface of the second lens element have a radius of curvature in the span of 29 mm to 30 mm and the second surface of the second lens element have a radius of curvature in the span of 424 mm to 432 mm. This design further improves the precision of the optical system.

In one embodiment of the invention, the first surface of the first lens element have a radius of curvature of in the span of in the span of 170.4794 mm to 170.8207 mm, the second surface of the first lens element have a radius of curvature in the span of 44.45366 mm to 44.48034 mm, the second surface of the second lens element have a radius of curvature in the span of 29.64111 mm to 29.6589 mm and the second surface of the second lens element have a radius of curvature in the span of 428.4743 mm to 428.6457 mm. This design further improves the precision of the optical system.

In one embodiment of the invention, the first surface of the first lens element have a radius of curvature of 170.65 mm, the second surface of the first lens element have a radius of curvature of 44.467 mm, the second surface of the second lens element have a radius of curvature of 29.62 mm and the second surface of the second lens element have a radius of curvature of 428.56 mm. This design further improves the precision of the optical system.

In one embodiment the first lens element may be in the span of 7.8 mm to 8.6 mm thick, where the center thickness may be in the span of 6.6 mm to 7.4 mm and the edge thickness may be in the span of 3.0 mm to 3.8 mm.

In one embodiment the first lens element may be in the span of 8.0 mm to 8.4 mm thick, where the center thickness may be in the span of 6.8 mm to 7.2 mm and the edge thickness may be in the span of 3.2 mm to 3.6 mm.

In one embodiment the first lens element may be 8.2 mm thick, where the center thickness may be 7.0 mm and the edge thickness may be 3.4 mm.

In one embodiment the second lens element may be in the span of 9.0 mm to 11 mm thick, where the center thickness may be in the span of 4.4 mm to 4.6 mm and the edge thickness may be in the span of 10.0 mm to 10.4 mm.

In one embodiment the second lens element may be in the span of 10.0 mm to 10.4 mm thick, where the center thickness may be in the span of 4.45 mm to 4.55 mm and the edge thickness may be in the span of 10.0 mm to 10.4 mm.

In one embodiment the second lens element may be 10.2 mm thick, where the center thickness may be in the span of 4.45 mm to 4.55 mm and the edge thickness may be 10.2 mm.

In one embodiment the third lens element may be in the span of 20 mm to 24 mm thick, where the center thickness may be in the span of 12 mm to 14 mm and the edge thickness may be in the span of 20 mm to 24 mm.

In one embodiment the third lens element may be in the span of 21 mm to 23 mm thick, where the center thickness may be in the span of 13.1 mm to 13.3 mm and the edge thickness may be in the span of 21 mm to 23 mm.

In one embodiment the third lens element may be in the span of 21.9 mm to 22.1 mm thick, where the center thickness may be 13.2 mm and the edge thickness may be in the span of 21.9 mm to 22.1 mm.

In one embodiment the diameter of the first lens element may be in the span of 35 mm to 45 mm, the diameter of the second lens element may be in the span of 35 mm to 45 mm and the diameter of the third lens element may be in the span of 175 mm to 225 mm.

In one embodiment the diameter of the first lens element may be in the span of 39 mm to 41 mm, the diameter of the second lens element may be in the span of 39 mm to 41 mm and the diameter of the third lens element may be in the span of 195 mm to 205 mm.

In one embodiment the diameter of the first lens element may be 40 mm, the diameter of the second lens element may be 40 mm and the diameter of the third lens element may be 200 mm.

In one embodiment any one or more surface of any lens of the optical system may be aspherical. This design can be used to more finely tune the performance of the optical system. The tuned performance may be aspects of the optical system such as focal length, general sharpness, accuracy, spherical aberration, astigmatism, coma, distortion or vignette.

The term “aspherical” surface refers to a surface which has a surface with a progressive or non-constant radius of curvature.

Examples of such aspherical surface displacements may be from the group of, but is not limited to, (0.08/Rz0.05), (0.08/Rz0.05)^{1/2}, (0.08/Rz0.05)^{1/3}, (0.08/Rz0.05)^{1/4}, (0.06/Rz0.05)^{1/2}, (0.1/Rz0.05)^{1/2}, (0.08/Rz0.04)^{1/2} and (0.08/Rz0.06)^{1/2}. The aspherical displacement that may be used depend on which performance of the optical system to tune.

In one embodiment the first lens element may be moveably arranged along the optical axis. This design can be used to more finely tune the focus of the optical system. The movement may be an offset, changed during usage of the system or while the system is in hibernation. The movement may for an example be operated manually, by a control unit or by an automated procedure.

In one embodiment the second lens element may be moveably arranged along the optical axis. This design can be used to more finely tune the focus of the optical system. The movement may be an offset, changed during usage of the system or while the system is in hibernation. The movement may for an example be operated manually, by a control unit or by an automated procedure.

In one embodiment the first and second lens elements may be moveably arranged along the optical axis and the first and second lens elements are further arranged to move in tandem. This design can be used to more finely tune the focus of the optical system. The movement may be an offset, changed during usage of the system or while the system is in hibernation. The movement may for an example be operated manually, by a control unit or by an automated procedure. In one embodiment at least one of the lens elements may be rotatably arranged around the optical axis. This design will reduce the influence of thermal hot spots and spatial fluctuations of the laser radiation.

In one embodiment, the material of the lens elements may be chosen according to the laser used and the requirements on the system as such. As a non limiting example, materials such as different kinds of glass, plastics, quartz, ZnSe, GaAs, Ge may be used for any lens and in any combination. The refractive index may for an example be 1.45, 1.44968 or in the span of 1.4493 to 1.4499.

In one embodiment, the power of the utilized laser may be between 20 and 60 kW.

The laser source may be at least one from the group comprising gas lasers, solid-state lasers, fiber lasers, photonic crystal lasers, semiconductor lasers, dye lasers and free-electron lasers, or any combination thereof. The laser source may for an example operate in continuous wave operation, pulsed operation with Q-switching, mode-locking or pulsed pumping. Any combination is possible, for an example a continuous wave fiber laser with a Yb solid state source.

The optical system may be optimized depending on different laser sources and utilizations.

According to a second aspect, the present invention relates to an optical device for focusing a high energy laser at an extended distance. The optical device may comprise an optical system according to any embodiment of the first aspect, a housing at least partially encapsulating the optical system, an inlet for attaching a laser source and an outlet for emitting a focused high energy laser.

In one embodiment, the optical device may utilize a fiber laser or any other laser source previously discussed.

In one embodiment, the optical device may be cooled in a passive manner or actively, by for an example a liquid, a gas, a peltier device, a heatsink or any combination thereof.

### SHORT DESCRIPTION OF THE APPENDED DRAWINGS

The invention is described in the following illustrative and non-limiting detailed description of exemplary embodiments, with reference to the appended drawings, wherein:

FIG. 1 is a cross sectional side view of an optical system according to a first aspect of the present invention.

FIG. 2 is a cross sectional side view of an optical system according to one embodiment of the invention that is mounted in an enclosure.

FIG. 3 is a cross sectional side view of the first lens element according to one embodiment of the invention.

FIG. 4 is a cross sectional side view of the second lens element according to one embodiment of the invention.

FIG. 5 is a cross sectional side view of the third lens element according to one embodiment of the invention.

All figures are schematic, not necessarily to scale, and generally only show parts which are necessary in order to elucidate the invention, wherein other parts may be omitted or merely suggested. Throughout the figures the same reference signs designate the same, or essentially the same features.

### DETAILED DESCRIPTION OF PREFERRED EMBODIMENTS OF THE INVENTION

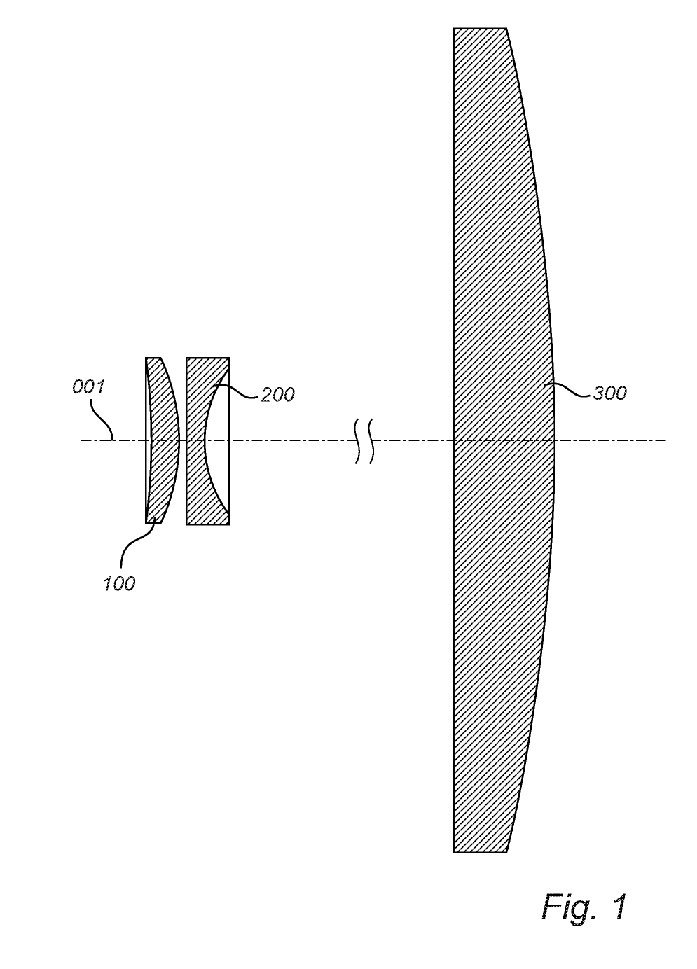

FIG. 1 shows an optical system comprising a first lens element (100), a second lens element (200) and a third lens element (300). The first lens element has a first surface (110) and a second surface (120). The first surface is concave and the second surface is convex. Further, the first lens element has a thickness (170), a central thickness (160) and an edge thickness (150). The second lens element (200) has a first surface (210) and a second surface (220). The first surface of the second lens element is essentially flat, the second surface of the second lens element is concave. Further, the second lens element has a thickness (270), a central thickness (260) and an edge thickness (250). The third lens element has a first surface (310) and a second surface (320). The first surface of the third lens element is essentially flat, the second surface of the third lens element is convex. Further, the third lens element has a thickness (370), a central thickness (360) and an edge thickness (350). All lens elements are aligned along an optical axis (001).

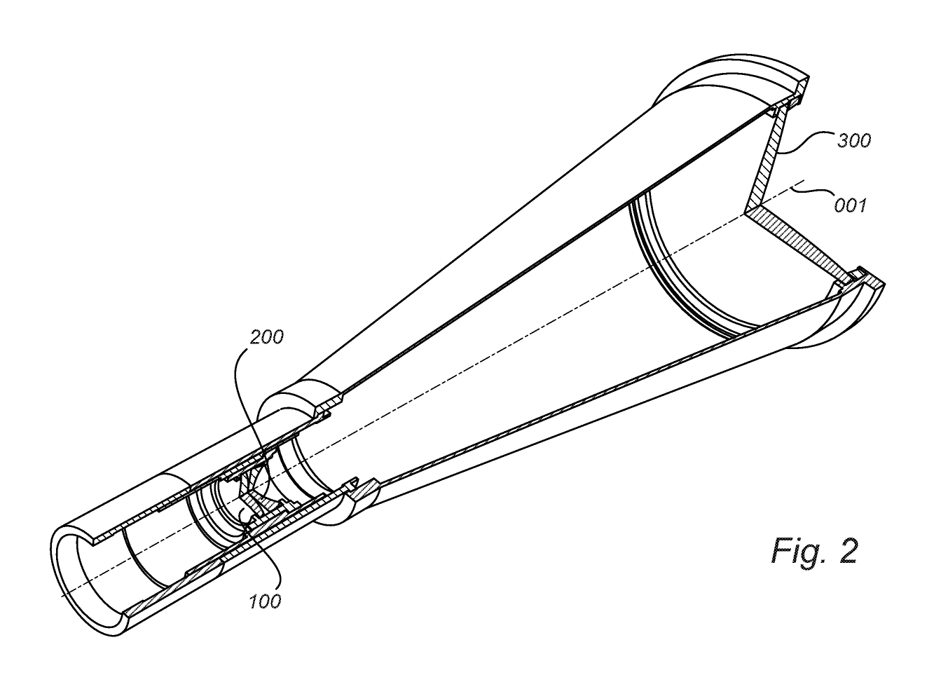

FIG. 2 shows an optical device housing an optical system. The optical system comprising a first lens element (100), a second lens element (200) and a third lens element (300). All lens elements are aligned along an optical axis (001) in the center of the optical device.

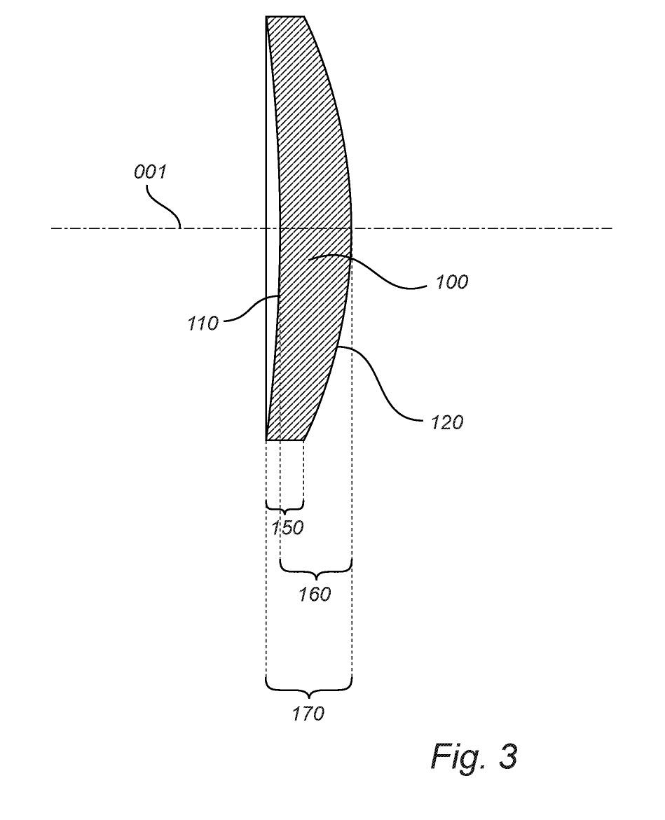

FIG. 3 shows the first lens element. The first lens element has a first surface (110) and a second surface (120). The first surface is concave and the second surface is convex. Further, the first lens element has a thickness (170), a central thickness (160) and an edge thickness (150).

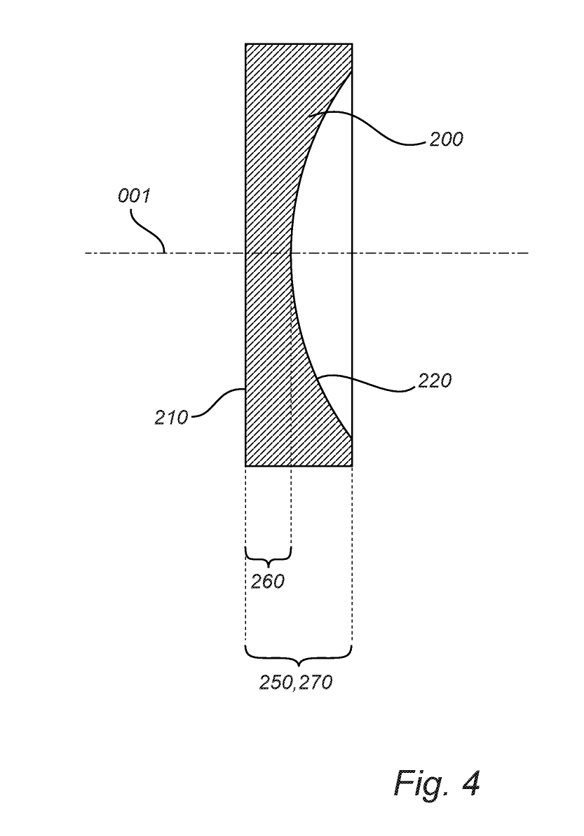

FIG. 4 shows the second lens element. The second lens element has a first surface (210) and a second surface (220). The first surface is concave and the second surface is convex. Further, the second lens element has a thickness (270), a central thickness (260) and an edge thickness (250).

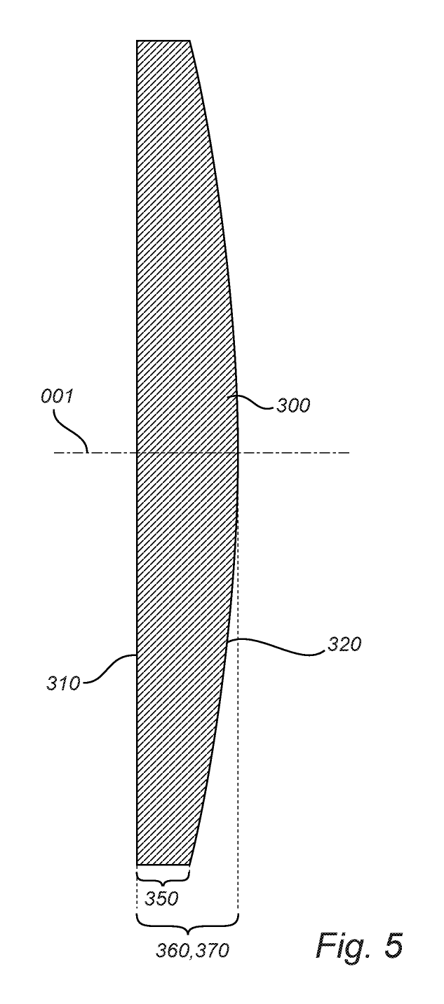

FIG. 5 shows the third lens element. The third lens element has a first surface (310) and a second surface (320). The first surface is concave and the second surface is convex. Further, the third lens element has a thickness (370), a central thickness (360) and an edge thickness (350).

Aspects of a general optical system are well known in the art and will not be described in greater detail.

With the above-described configuration, the lens system is adapted to efficiently contribute to the demands put on the system, while allowing the use of a high energy laser.

While specific embodiments have been described, the skilled person will understand that various modifications and alterations are conceivable within the scope as defined in the appended claims.

1. An optical system for focusing a high energy laser at an extended distance, where the extended distance is more than 10 meters, the optical system comprises, in order as viewed from the laser source, along an optical axis of the system:
a first lens element having a first surface and a second surface, where the first surface is concave and the second surface is convex;
a second lens element having a first surface and a second surface, where the first surface is flat and the second surface is concave;
a third lens element having a first surface and a second surface, where the first surface is flat and the second surface is convex; and
where the distance between the second lens element and the third lens element is larger than the distance between the first lens element and the second lens element.

2. An optical system according to claim 1, wherein the first surface of the first lens element have a radius of curvature of in the span of in the span of 162 mm to 179 mm; the second surface of the first lens element have a radius of curvature in the span of 42 mm to 47 mm; the second surface of the second lens element have a radius of curvature in the span of 28 mm to 31 mm and the second surface of the second lens element have a radius of curvature in the span of 407 mm to 450 mm.

3. An optical system according to claim 1, wherein the first surface of the first lens element have a radius of curvature of in the span of in the span of 169 mm to 172 mm; the second surface of the first lens element have a radius of curvature in the span of 44 mm to 45 mm; the second surface of the second lens element have a radius of curvature in the span of 29 mm to 30 mm and the second surface of the second lens element have a radius of curvature in the span of 424 mm to 432 mm.

4. An optical system according to claim 1, wherein the first surface of the first lens element have a radius of curvature of in the span of 170.4794 mm to 170.8207 mm;
the second surface of the first lens element have a radius of curvature in the span of 44.45366 mm to 44.48034 mm; the second surface of the second lens element have a radius of curvature in the span of 29.64111 mm to 29.6589 mm and the second surface of the second lens element have a radius of curvature in the span of 428.4743 mm to 428.6457 mm.

5. An optical system according to claim 1, wherein the first surface of the first lens element have a radius of curvature of 170.65 mm; the second surface of the first lens element have a radius of curvature of 44.467 mm; the second surface of the second lens element have a radius of curvature of 29.62 mm and the second surface of the second lens element have a radius of curvature of 428.56 mm.

6. An optical system according to claim 1, wherein at least one surface of at least one lens element having a cross-section of an aspherical shape when cut with a plane parallel to the light axis.

7. An optical system according to claim 1, wherein the first lens element is moveably arranged along the optical axis.

8. An optical system according to claim 1, wherein the second lens element is moveably arranged along the optical axis.

9. An optical system according to claim 1, wherein the first and second lens elements are moveably arranged along the optical axis, and the first and second lens elements are further arranged to move in tandem.

10. An optical system according to claim 1, wherein at least one of the lens elements is rotatably arranged around the optical axis.

11. An optical system according to claim 1, wherein at least one of the lens elements is made from a material having a refractive index in the span of 1.4493 to 1.4499.

12. An optical system according to claim 1, wherein the diameter of the first lens element is 40 mm, the diameter of the second lens element is 40 mm and the diameter of the third lens element is 200 mm.

13. An optical device for focusing a high energy laser at an extended distance, the device comprises:
an optical system according to claim 1;
a housing at least partially encapsulating the optical system;
an inlet for attaching a laser source;
an outlet for emitting a focused high energy laser.

14. A mobile optical unit for focusing a high energy laser at an extended distance, the unit comprises:
an optical device according to claim 13;
a laser source attached to the inlet;

15. A mobile optical unit according to claim 14, wherein the laser source utilizes a fiber laser.
